(19) United States
(12) Patent Application Publication
(10) Pub. No.: US 2005/0262681 A1
(43) Pub. Date: Dec. 1, 2005

(54) Door of drum washer and assembling method for the same

(75) Inventors: Seong No Yoon, Changwon-si (KR); Bong Sang Lee, Changwon-si (KR); Sung Rak Gong, Busan (KR); Bo Yeon Kim, Changwon-si (KR); Seong Yeol Lee, Daegu (KR); Dae Hee Kwon, Busan (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/034,823

(22) Filed: Jan. 14, 2005

(30) Foreign Application Priority Data
Jun. 1, 2004 (KR) P2004-39498
Jun. 1, 2004 (KR) P2004-39499
Jun. 1, 2004 (KR) P2004-39500

(51) Int. Cl. B23P 11/00; D06F 37/10

(52) U.S. Cl. 29/428; 68/196; 68/3 R

(57) ABSTRACT

A door of a drum washer and an assembling method for the same are disclosed, in which a structure of a door is improved to facilitate assembly of the door and make appearance of the door good. The door of a drum washer includes an upper cover having a hollow, a central portion downwardly tapered at a predetermined angle and a main boss formed at a predetermined length outside the rear, a center cover connected to an lower portion of the upper cover, having an connecting boss coupled to the main boss, and a lower cover connected to an lower portion of the center cover, having an connecting boss groove corresponding to the connecting boss. The assembling method includes connecting an upper cover provided with a main boss to a center cover provided with an connecting boss corresponding to the main boss, inserting a door glass to a lower portion at an inner circumference of the upper cover, and connecting a lower cover provided with an connecting boss groove corresponding to the connecting boss of the center cover to a lower portion of the center cover.

This application claims the benefit of Korean Application Nos. P2004-039498 filed on Jun. 1, 2004, P2004-039499 filed on Jun. 1, 2004 and P2004-039500 filed on Jun. 1, 2004, which are hereby incorporated by reference as if fully set forth herein.

### BACKGROUND OF THE INVENTION

1. Field of the Invention

The present invention relates to a drum washer, and more particularly to, a door of a drum washer and an assembling method for the same, in which a structure of the door is improved to facilitate assembly of the door and make appearance of the drum washer good.

2. Discussion of the Related Art

Generally, a washer uses an electric motor as a main power and performs washing, rinsing and dehydrating operations to remove dirt on the laundry using action of detergents and water. The washer includes a mechanical portion transferring energy to a power unit, such as an electric motor, and the laundry, a controller controlling washing steps and a water supply and a drainage supplying and draining water.

Also, the washer is divided into a cylinder type, an agitator type, and a pulsator type depending on a washing type.

The agitator type is to wash the laundry by rotating a wing shaped agitator at the center of a washing tub in left and right directions. The pulsator type is to wash the laundry using swift flow generated by rotating a circular plate shaped pulsator. The cylinder type is to wash the laundry by impact generated when the laundry is lifted and dropped by a plurality of projections provided at a drum as the drum is horizontally rotated at low speed after putting water, detergents and the laundry inside the drum.

The cylinder type is on an increasing trend because damage of the laundry little occurs and a small amount of water is required.

FIG. 1 is a perspective view of a related art drum washer.

Referring to FIG. 1, a related art drum washer 10 includes a cabinet 11 constituting appearance, a door 20 provided at the center of the front of the cabinet 11, a detergent box 12 formed at the upper portion of the front of the washer 10 to receive detergents, and a controller 13 controlling the operation of the washer 10.

In more detail, the door 20 includes a door frame 21 constituting appearance, a deco band 22 formed at the rim of the front of the door frame 21, and a door glass 23 recessed in the deco band 22 and projected into the washer.

The door glass 23 is recessed into the washer and is made of a transparent material to allow a user to directly recognize the rotation state of the laundry inside the drum.

The aforementioned drum washer 10 is operated in such a manner that a user fills detergents in the detergent box 12, puts the laundry into the drum, and manipulates a power button provided at the controller 13 and a dial controlling a washing level.

Meanwhile, if the washing operation ends, a drying operation is performed. If the drying operation of the laundry ends, the drum inside the washer 100 is stopped.

In the door of the related art drum washer, it is general that the door frame is formed in a single body with the deco band. The door frame and the deco band are integrally lustrous or lusterless. In this case, it is difficult to distinguish the deco band from the door frame and exert a comparison effect between a lustrous portion and a semi-lustrous portion. This could lead to undesirable appearance of the washer.

### SUMMARY OF THE INVENTION

Accordingly, the present invention is directed to a door of a drum washer and an assembling method for the same that substantially obviates one or more problems due to limitations and disadvantages of the related art.

An object of the present invention is to provide a door of a drum washer and an assembling method for the same in which a structure of a door is improved to facilitate assembly of the door.

Another object of the present invention is to provide a door of a drum washer and an assembling method for the same in which a structure of a door is improved to make appearance of the drum washer good.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a door of a drum washer includes an upper cover having a hollow, a central portion downwardly tapered at a predetermined angle and a main boss formed at a predetermined length outside the rear, a center cover connected to an lower portion of the upper cover, having an connecting boss coupled to the main boss, and a lower cover connected to an lower portion of the center cover, having an connecting boss groove corresponding to the connecting boss.

Preferably, the door of a drum washer further includes a fitting member penetrating the connecting boss and the connecting boss groove and being inserted into the main boss. The connecting boss groove includes a fitting member penetrating hole at the center.

Preferably, the upper cover includes at least one hook at the rim while the center cover includes a hook fitting groove corresponding to the hook at the rim.

Preferably, the hook includes an inner hook formed in the inner circumference at the rim of the upper cover and an outer hook formed in the outer circumference at the rim of the upper cover. Specifically, the hook has a vertical end with elasticity.

Preferably, the center cover includes a center rib downwardly extended in the inner circumference at the rim and the lower cover includes a lower rib formed in the inner circumference at the rim to correspond to the center rib.

Preferably, the center rib includes a center undercut projected at the outer circumference and the lower rib includes a lower undercut coupled to the center undercut.

Preferably, the upper cover includes a center boss downwardly extended from the rear and the center cover includes a center boss groove corresponding to the center boss. Preferably, the door of a drum washer further includes a fitting member penetrating the center boss groove and being inserted into the center boss.

Preferably, the center boss groove includes a fitting member penetrating hole formed stepwise with the center boss groove.

Preferably, the center cover includes at least one bottom hook groove formed with a predetermined width at the inner rim, and the lower cover includes a bottom hook corresponding to the bottom hook groove.

Preferably, the door of a drum washer further includes a door glass inserted between the upper cover and the lower cover.

Preferably, at least one of the upper cover, the center cover and the lower cover includes a grip portion for placing a grip of the door therein. Further, at least one of the upper cover, the center cover and the lower cover includes a door hinge groove for placing a door hinge that connects the door to a main body of the drum washer.

Preferably, at least one of the upper cover, the center cover and the lower cover is formed by injection molding. The upper cover and the center cover are surface-treated to have luster different from each other.

In another aspect, an assembling method for a door of a drum washer comprising connecting an upper cover provided with a main boss to a center cover provided with an connecting boss corresponding to the main boss, inserting a door glass to a lower portion at an inner circumference of the upper cover, and connecting a lower cover provided with an connecting boss groove corresponding to the connecting boss of the center cover to a lower portion of the center cover.

Preferably, the assembling method further includes fixing a fitting member into the main boss through an inner portion of the connecting boss and the connecting boss groove.

Preferably, the step of connecting the upper cover to the center cover includes fixing a hook formed in the upper cover to a hook groove formed in the center cover.

Preferably, the step of connecting the center cover to the lower cover includes coupling a center undercut formed in the center cover to a lower undercut formed in the lower cover.

Preferably, the step of connecting the upper cover to the center cover includes coupling a center boss formed in the upper cover to a center boss groove formed in the center cover.

Preferably, the step of connecting the upper cover to the center cover further includes fixing a fitting member into the center boss through the center boss groove.

Preferably, the step of connecting the center cover to the lower cover further includes fixing a bottom hook groove formed in the center cover to a bottom hook formed in the lower cover.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a related art drum washer;

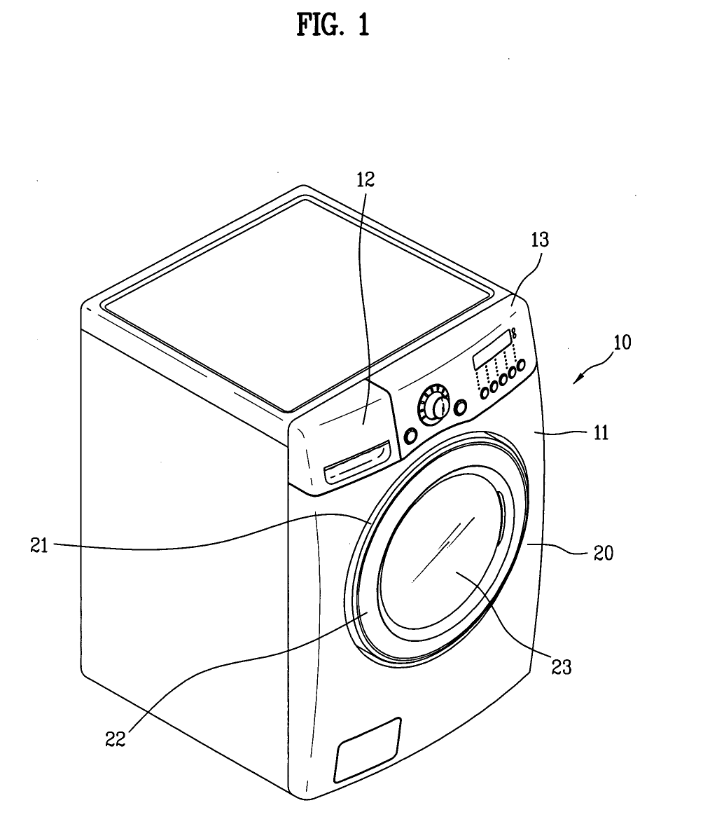

FIG. 2 is a perspective view illustrating a drum washer according to the present invention;

FIG. 3 is an exploded perspective view illustrating a door frame according to the present invention;

FIG. 4 is a rear perspective view illustrating an upper cover according to the first embodiment of the present invention;

FIG. 5 is a front perspective view illustrating a center cover according to the first embodiment of the present invention;

FIG. 6 is a rear perspective view illustrating a center cover according to the first embodiment of the present invention;

FIG. 7 is a front perspective view illustrating a lower cover according to the first embodiment of the present invention;

FIG. 8 is a partial sectional view illustrating the state that an upper cover and a center cover are connected to each other in accordance with the first embodiment of the present invention;

FIG. 9 is a partial sectional view illustrating the state that an upper cover, a center cover, and a lower cover are connected to one another in accordance with the first embodiment of the present invention;

FIG. 10 is a rear perspective view illustrating an upper cover according to the second embodiment of the present invention;

FIG. 11 is a front perspective view illustrating a center cover according to the second embodiment of the present invention;

FIG. 12 is a front perspective view illustrating a lower cover according to the second embodiment of the present invention;

FIG. 13 is a partial sectional view illustrating the state that an upper cover and a center cover are connected to each other in accordance with the second embodiment of the present invention; and

FIG. 14 is a partial sectional view illustrating the state that an upper cover, a center cover, and a lower cover are connected to one another in accordance with the second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

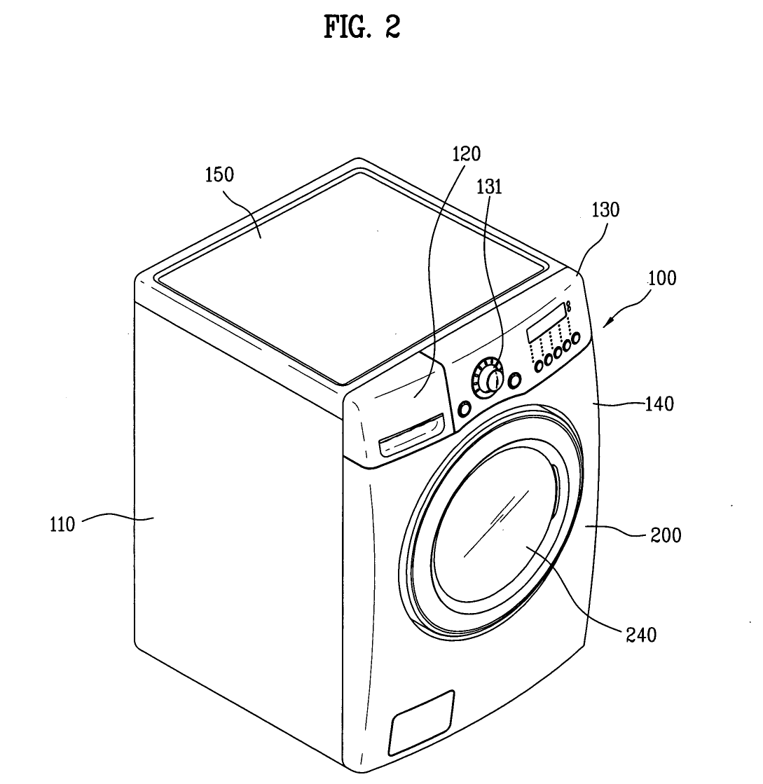

An example of a drum washer according to the present invention will be described with reference to FIG. 2.

FIG. 2 is a perspective view illustrating a drum washer according to the present invention.

As shown in FIG. 2, a drum washer 100 of the present invention includes a cabinet 110 constituting appearance, a top cover 150 built in an upper end of the cabinet 110 to shield the inside of the cabinet 110, and a front cover 140 built in the front of the cabinet 110.

In more detail, a door 200 is provided at the center of the front cover 140 to put the laundry into a drum therethrough. The door 200 includes a door frame constituting appearance and a door glass 240 shielded by the door frame and recessed into the drum washer. The door glass 240 is made of a transparent material to allow a user to directly recognize the state inside the drum washer. A control panel 130 is provided at the upper portion of the front cover 140. A detergent box 120 and a controller 131 are provided at one side of the control panel 130. The detergent box 120 receives detergents while the controller 131 controls the operation of the washer and inputs washing conditions.

The operation of the aforementioned drum washer according to the present invention will now be described.

First, a user opens the detergent box 120 and fills detergents therein. Then, the user opens the door 200 to put the laundry into the washer. Afterwards, the user pushes a power button provided at the controller 131 and an input button for washing conditions to drive the washer.

If the above steps end, washing, rinsing and drying steps are performed depending on the input washing conditions.

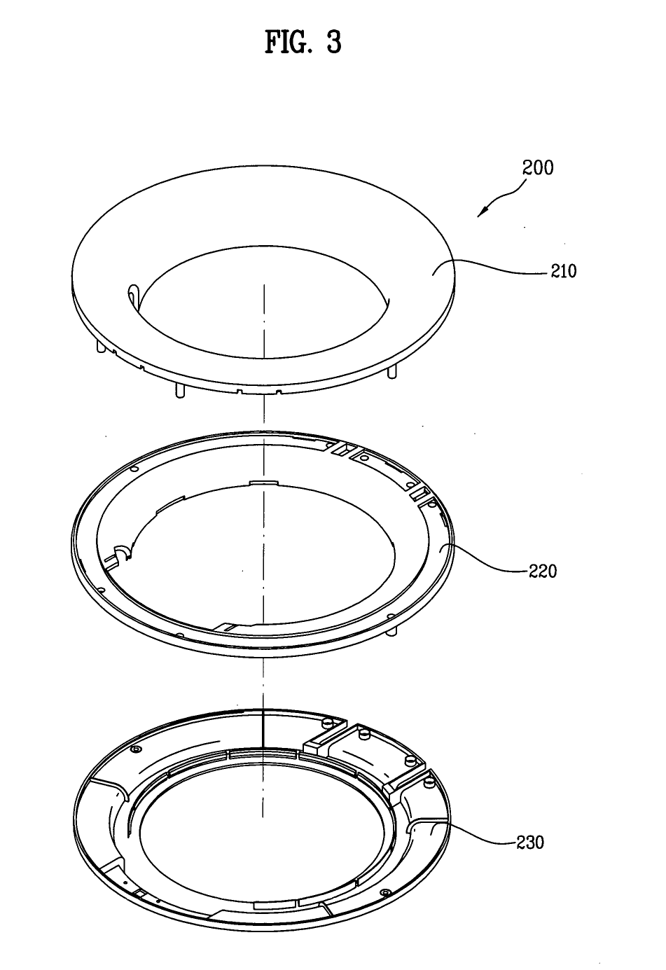

FIG. 3 is an exploded perspective view illustrating the door frame according to the first embodiment of the present invention.

Referring to FIG. 3, the door frame according to the present invention includes an upper cover 210 constituting the front, a center cover 220 built at the lower portion of the upper cover 210 and connected to the upper cover, and a lower cover 230 built at the lower portion of the center cover 220, constituting the bottom.

The respective covers of the door frame are separately formed by injection molding and are fixed to one another by a fitting member.

In more detail, the upper cover 210 and the center cover 220 have luster different from each other to be distinguished from each other when viewed from the front side of the washer.

For example, the upper cover 210 absorbs light to constitute a lusterless portion and the center cover 220 reflects light to constitute a lustrous portion. Thus, the upper cover 210 and the center cover 220 can be formed by injection molding to give esthetic appreciation when viewed from the outside.

Therefore, since the upper cover 210, the center cover 220 and the lower cover 230 are separately assembled, surfaces of the respective covers can separately designed and made.

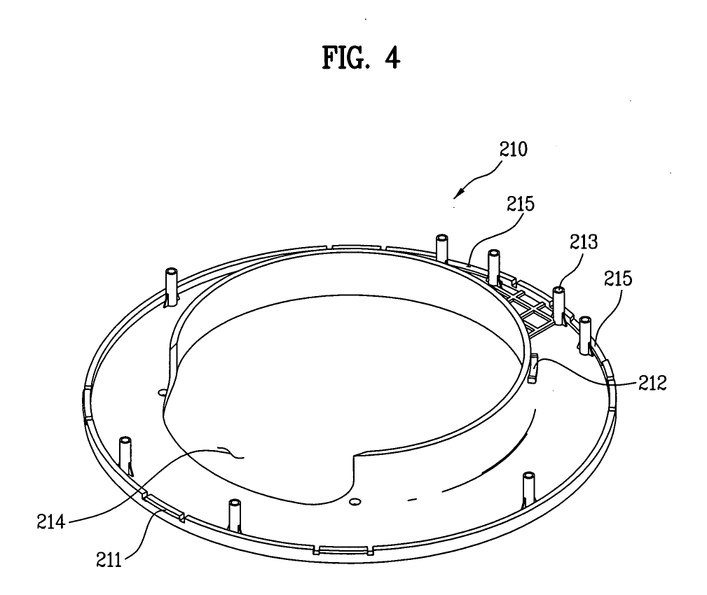

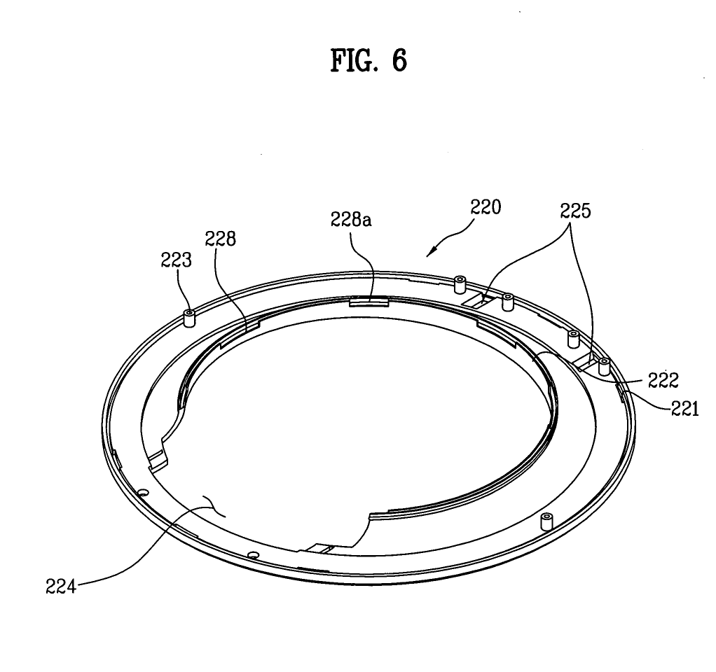

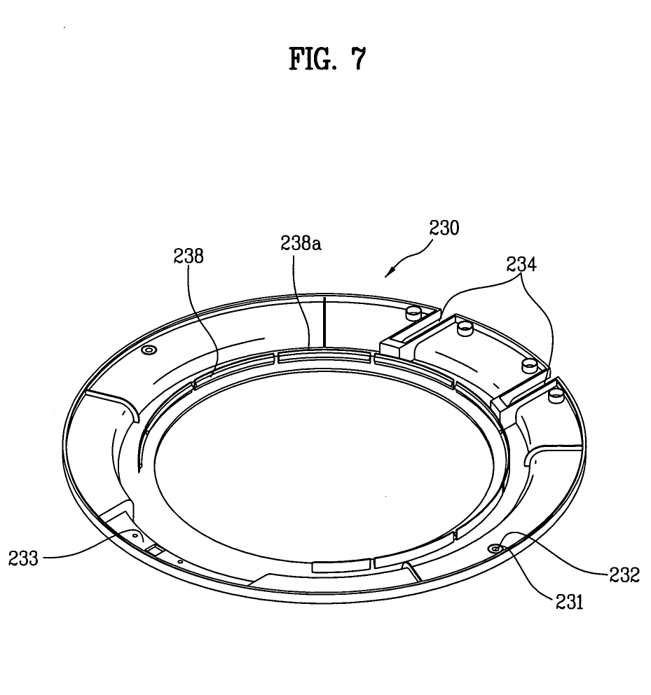

The respective covers will be described in more detail with reference to FIG. 4 to FIG. 7.

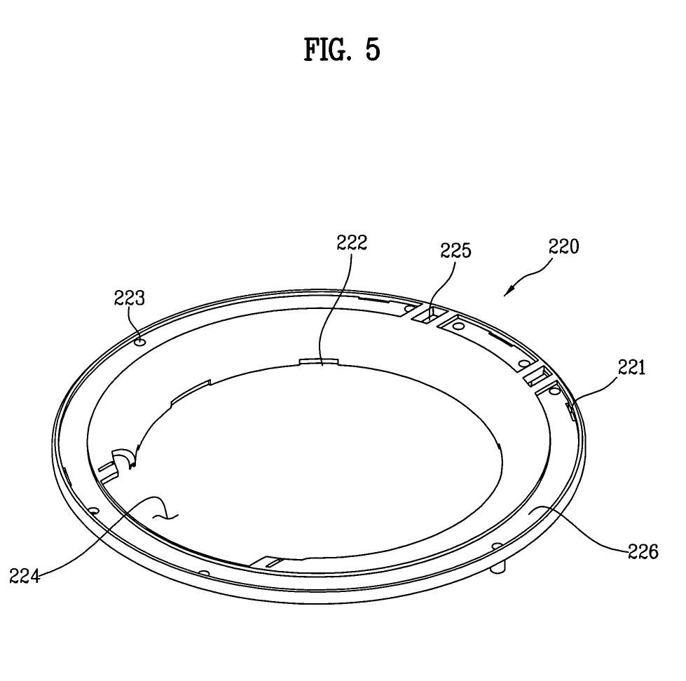

Referring to FIG. 4 and FIG. 5, the upper cover 210 has a circular band shape and constitutes a curve recessed toward the inner side.

In more detail, the upper cover 210 includes an outer hook 211 formed at the rim of the outer circumference to be connected to the center cover 220 and an inner hook 212 formed at the rim of the inner circumference to be fixed to the center cover 220.

A main boss 213 is formed outside the rear side of the upper cover at a predetermined length in a vertical direction. The main boss 213 is connected to the center cover 220 and the lower cover 230.

Meanwhile, a grip portion 214 for placing a grip therein is formed at one side of the inner circumference of the upper cover to allow a user to open and close the door.

A door hinge groove 215 is formed at a side opposite to the grip portion 214 to place a door hinge therein. The door hinge allows the door 200 to be rotatably provided in the washer 100.

As described above, the upper cover 210 constitutes the front of the door 200, and appearance of the washer depends on luster or texture of the upper cover 210.

For example, the upper cover 210 may be coated with a material reflecting light or its upper surface may be treated with hairline. Alternatively, the upper cover 210 may be coated with a material absorbing light, such as chrome plating, to feel weight.

Referring to FIG. 4 to FIG. 7, the center cover 220 is connected to the lower portion of the upper cover 210.

The center cover 220 includes a recess portion 226 recessed in a circular band shape with a predetermined width and depth and at least one connecting boss 223 formed at the center of the recess portion and downwardly extended at a predetermined length.

In more detail, the connecting boss 223 is formed with a diameter and depth into which the main boss 213 can be inserted. A groove is formed at the bottom of the connecting boss to pass a fitting member therethrough.

Further, an outer hook groove 221 is formed at the outer side of the recess portion 226 to insert the outer hook 211 formed at the outer circumference of the upper cover 210 therein. An inner hook groove 222 is formed at the rim of the inner circumference of the center cover to hook the inner hook 212 formed at the rim of the inner circumference of the upper cover 210.

Meanwhile, a grip portion 224 and a door hinge groove 225 are formed in the same manner as the upper cover 210.

The assembly steps of connecting the upper cover 210 to the center cover 220 will now be described.

The main boss 213 is inserted into an inner groove of the connecting boss 223. The upper cover 210 is pressurized so that the outer hook 211 and the inner hook 212 are respectively inserted into the outer hook groove 221 and the inner hook groove 222.

Once the outer hook 211 and the inner hook 212 are respectively inserted into their grooves, they are not likely to be removed from their grooves.

The center cover 220 includes a center rib 228 formed at the rim of the inner circumference to be downwardly extended in a vertical direction and a band shaped center undercut 228a projected at a certain height at the outer circumference of the center rib 228.

Specifically, the center undercut 228a is engaged with a lower undercut 238a formed in the lower cover 230 so that the center cover 220 is tightly coupled to the lower cover 230.

The lower cover 230 includes an connecting boss groove 231 for inserting the connecting boss 223 projected from the rear side of the center cover 220 and a fitting member penetrating hole 232 formed at the center of the connecting boss groove 231 to pass through the fitting member.

In the same manner as the upper cover 210 and the center cover 220, a door hinge groove 234 and a grip portion 233 are formed to oppose each other.

The lower cover 230 further includes a lower rib 238 spaced apart from the inner circumference of the lower cover 230 at a predetermined distance and the lower undercut 238a surrounding the outer circumference of the lower rib 238 in a band shape.

In more detail, the lower undercut 238a is coupled to the center undercut 228a formed in the center cover 220 so that the center cover 220 is tightly fixed to the lower cover 230.

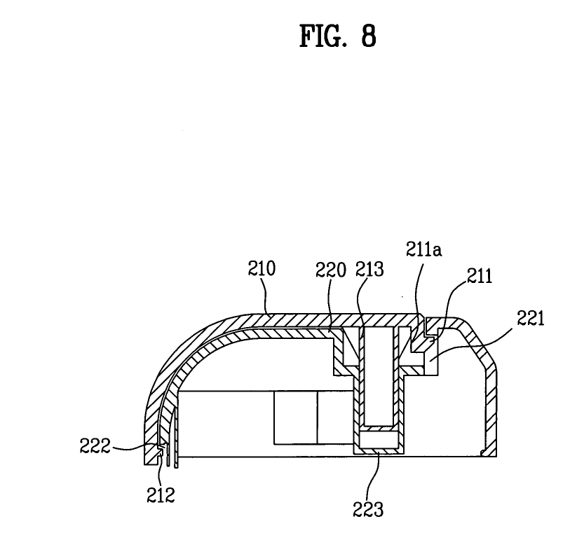

FIG. 8 is a partial sectional view illustrating the state that the upper cover is connected to the center cover in accordance with the first embodiment of the present invention.

Referring to FIG. 8, the upper cover 210 and the center cover 220 are fixed to each other by a hook.

As described above, at least one outer hook 211 downwardly formed in a vertical direction at the rim of the outer circumference of the upper cover 210 is inserted into the outer hook groove 221 formed outside the rim of the center cover 220.

The inner hook 212 projected in a horizontal direction at the rim of the inner circumference of the upper cover 210 is hooked over the inner hook groove 222 formed at the rim of the inner circumference of the center cover 220.

The order of fixing the hooks 211 and 212 is as follows.

First, the inner hook 212 is hooked over the inner hook groove 222. The upper portion of the upper cover 210 is downwardly pressurized so that the outer hook 211 is inserted into the outer hook groove 221.

Specifically, as shown, the outer hook 211 is projected in a horizontal direction at a predetermined length and is pointed toward the lower portion.

Furthermore, since a vertical end 211a of the hook 211 is formed with elasticity, it is inwardly bent when the pointed portion of the hook 211 descends along the rim of the center cover. If the hook 211 is fully inserted into the outer hook groove 221, the vertical end 211a of the hook 211 returns to the original position so that the hook 211 is not removed from the hook groove 221.

Meanwhile, the main boss 213 is inserted into a groove formed at the center of the connecting boss 223. Accordingly, it is preferable that the inner groove of the connecting boss 223 has a diameter equal to an outer diameter of the main boss 213.

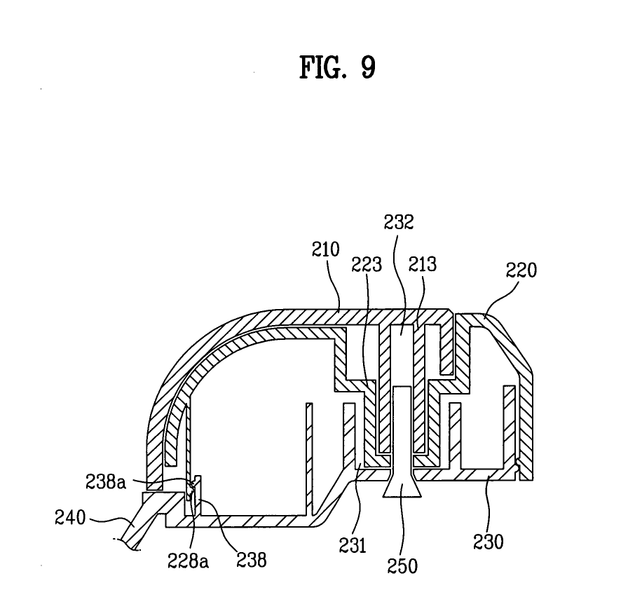

FIG. 9 is a partial sectional view illustrating the state that the upper cover, the center cover and the lower cover are connected to one another.

Referring to FIG. 9, in a state that the main boss 213 is inserted into the connecting boss 223, a coupling body of the upper cover 210 and the center cover 220 is fixed to the lower cover 230. That is, the connecting boss 223 is fixed to the connecting boss groove 231 formed at the bottom of the lower cover 230.

At this time, the lower undercut 238a formed in the lower cover 230 ascends along the center undercut 228a formed in the center cover 220 and pressurizes the lower cover 230 so that the lower undercut 238a is positioned above the center undercut 228a formed in the center cover 220.

A fitting member 250 is provided to pass the center of the main boss 213 and the connecting boss 223 through the fitting member penetrating hole 232 from the bottom of the lower cover 230.

By undergoing the above steps, the upper cover 210, the center cover 220 and the lower cover 230 are connected to one another in a single body by the fitting member 250.

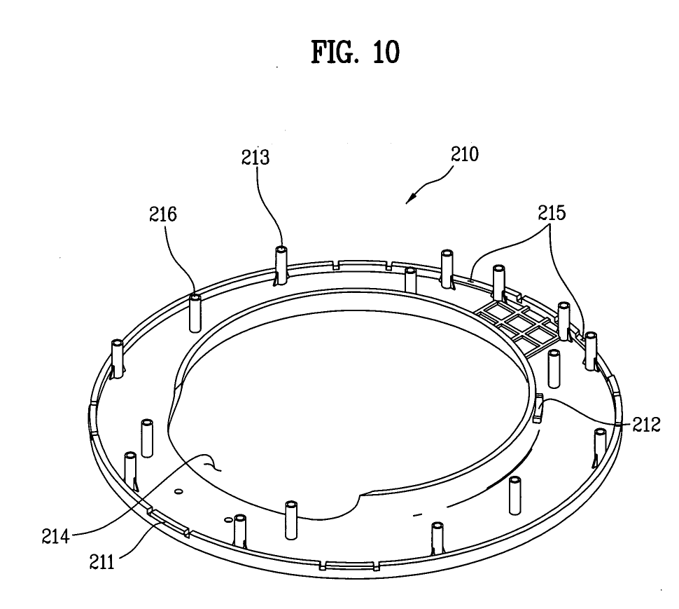

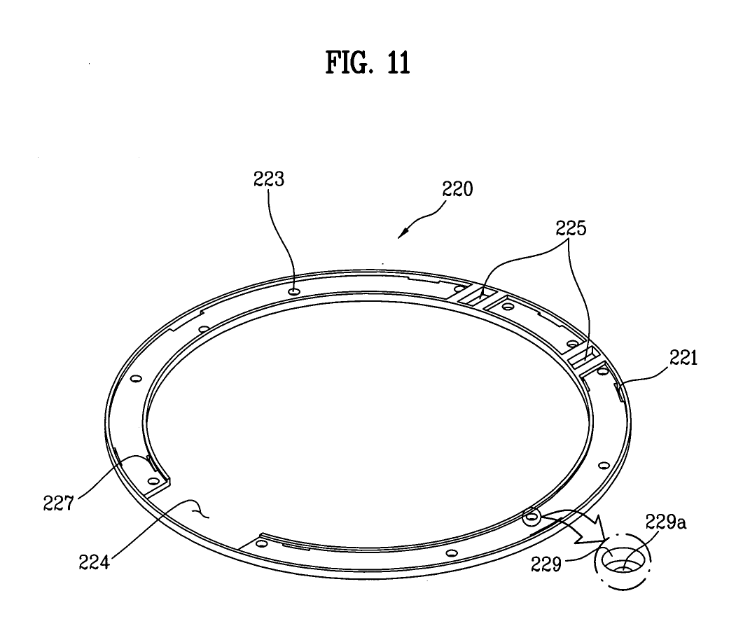

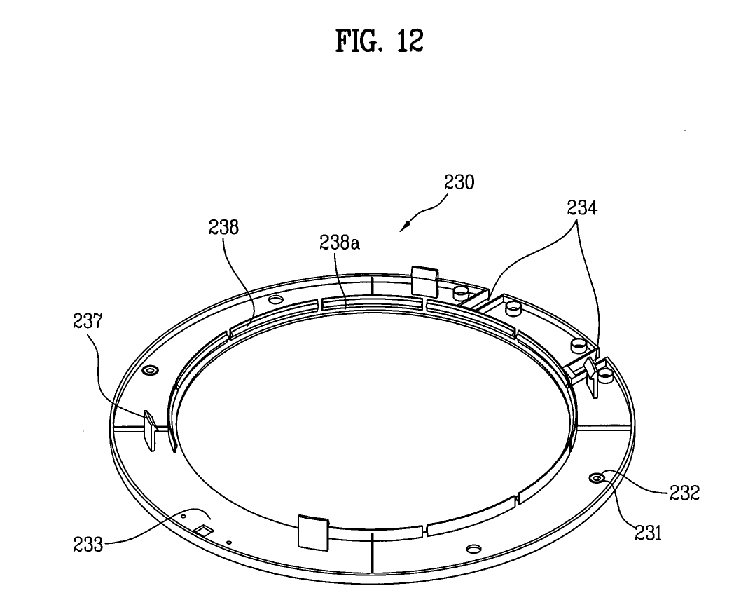

FIG. 10 is a rear perspective view illustrating an upper cover according to the second embodiment of the present invention, FIG. 11 is a front perspective view illustrating a center cover according to the second embodiment of the present invention, and FIG. 12 is a front perspective view illustrating a lower cover according to the second embodiment of the present invention.

Referring to FIG. 10 to FIG. 12, the upper cover 210 includes a center boss 216 formed at one side of the rear and extended at a predetermined length.

In more detail, the center boss 216 is to connect the upper cover 210 to the center cover 220. The center boss 216 may be formed near the inner rim of the upper cover 210.

In the same manner as the first embodiment of the present invention, the upper cover 210 includes an outer hook 211 and an inner hook 212. The upper cover 210 is fixed to the center cover 220 by the hooks 211 and 212.

Meanwhile, the center cover 220 includes a center boss groove 229 for inserting the center boss 216 formed in the upper cover 210 and a fitting member penetrating hole 229a positioned at the center of the center boss groove 229. Specifically, the center boss groove 229 is formed at the inner rim of the center cover 220 to insert the center boss 216 therein.

Therefore, as described above, after the center boss 216 is inserted into the center boss groove 229, a fitting member is fixed into the center boss 216 through the fitting member penetrating hole 229a.

Furthermore, at least one bottom hook groove 227 with a predetermined width is formed at the inner rim of the center cover 220.

The bottom hook groove 227 is to insert a bottom hook 237 formed in the lower cover 230 therein. At least one bottom hook 237 is formed at one side of the upper portion of the lower cover at a predetermined height. The bottom hook 237 is inserted into the bottom hook groove 227 so that the center cover 220 is tightly fixed to the lower cover 230.

Therefore, the lower cover 230 is primarily connected to the center cover 220 by the main boss 213 and the fitting member and is secondarily fixed to the center cover 220 by the bottom hook 237.

Since the bottom hook 237 has the same function as the hooks 211 and 212 formed in the upper cover 210, its detailed description will be omitted.

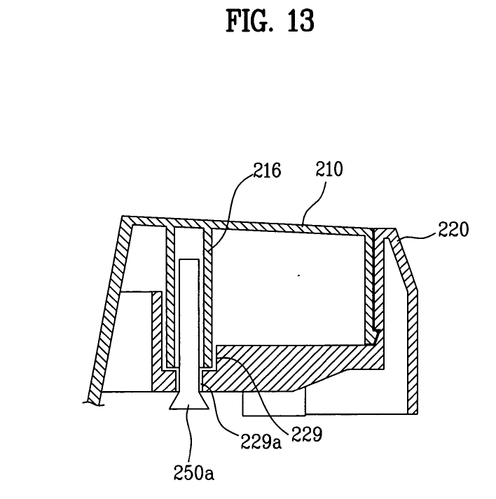

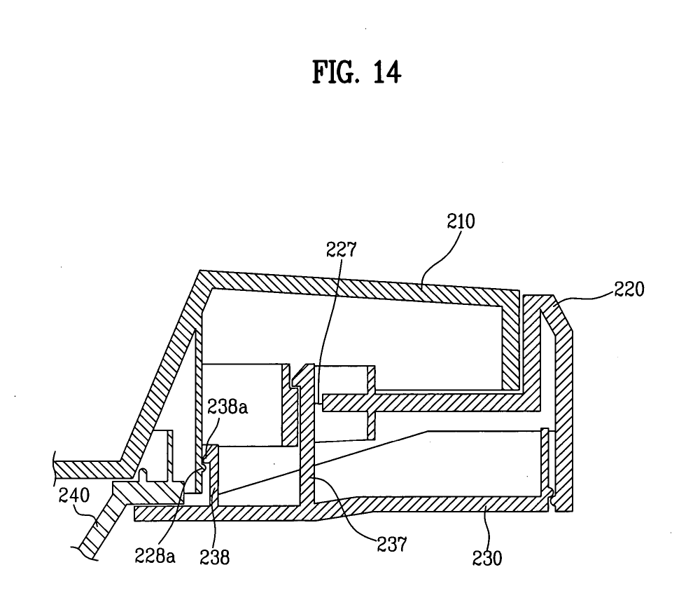

FIG. 13 is a partial sectional view illustrating the state that the upper cover and the center cover are connected to each other in accordance with the second embodiment of the present invention, and FIG. 14 is a partial sectional view illustrating the state that the upper cover, the center cover, and the lower cover are connected to one another in accordance with the second embodiment of the present invention.

Referring to FIG. 13 and FIG. 14, after the center boss 216 formed in the upper cover 210 is inserted into the center boss groove 229 of the center cover 220, a fitting member 250a is tightened to be inserted into the center boss 216 from the bottom of the center cover 220.

The lower cover 230 or the center cover 220 is pressurized so that the bottom hook 237 projected at the lower cover 230 is inserted into the bottom hook groove 227 formed in the center cover 220. Before the upper cover 210, the center cover 220 and the lower cover 230 are completely connected to one another, the upper end of the door glass 240 is inserted between the lower end of the upper cover 210 and the upper side of the inner rim of the lower cover 230.

As described above, the door of the drum washer according to the present invention has the following advantages.

The upper cover, the center cover and the lower cover are easily assembled, and it is possible to facilitate the process steps of differing texture of the front portion of the door frame from texture of side portions of the door frame.

In addition, the door frame having fine and high-quality appearance can be obtained.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A door of a drum washer comprising:
an upper cover having a hollow, a central portion downwardly tapered at a predetermined angle and a main boss formed at a predetermined length outside the rear;
a center cover connected to an lower portion of the upper cover, having an connecting boss coupled to the main boss; and
a lower cover connected to an lower portion of the center cover, having an connecting boss groove corresponding to the connecting boss.

2. The door of a drum washer of claim 1, further comprising a fitting member penetrating the connecting boss and the connecting boss groove and being inserted into the main boss.

3. The door of a drum washer of claim 2, wherein the connecting boss groove includes a fitting member penetrating hole at the center.

4. The door of a drum washer of claim 1, wherein the upper cover includes at least one hook at the rim while the center cover includes a hook fitting groove corresponding to the hook at the rim.

5. The door of a drum washer of claim 4, wherein the hook includes an inner hook formed in the inner circumference at the rim of the upper cover and an outer hook formed in the outer circumference at the rim of the upper cover.

6. The door of a drum washer of claim 5, wherein the hook has a vertical end with elasticity.

7. The door of a drum washer of claim 1, wherein the center cover includes a center rib downwardly extended in the inner circumference at the rim and the lower cover includes a lower rib formed in the inner circumference at the rim to correspond to the center rib.

8. The door of a drum washer of claim 7, wherein the center rib includes a center undercut projected at the outer circumference and the lower rib includes a lower undercut coupled to the center undercut.

9. The door of a drum washer of claim 1, wherein the upper cover includes a center boss downwardly extended from the rear and the center cover includes a center boss groove corresponding to the center boss.

10. The door of a drum washer of claim 9, further comprising a fitting member penetrating the center boss groove and being inserted into the center boss.

11. The door of a drum washer of claim 10, wherein the center boss groove includes a fitting member penetrating hole formed stepwise with the center boss groove.

12. The door of a drum washer of claim 1, wherein the center cover includes at least one bottom hook groove formed with a predetermined width at the inner rim, and the lower cover includes a bottom hook corresponding to the bottom hook groove.

13. The door of a drum washer of claim 1, further comprising a door glass inserted between the upper cover and the lower cover.

14. The door of a drum washer of claim 1, wherein at least one of the upper cover, the center cover and the lower cover includes a grip portion for placing a grip of the door therein.

15. The door of a drum washer of claim 1, wherein at least one of the upper cover, the center cover and the lower cover includes a door hinge groove for placing a door hinge that connects the door to a main body of the drum washer.

16. The door of a drum washer of claim 1, wherein at least one of the upper cover, the center cover and the lower cover is formed by injection molding.

17. The door of a drum washer of claim 1, wherein the upper cover and the center cover are surface-treated to have luster different from each other.

18. An assembling method for a door of a drum washer comprising:
connecting an upper cover provided with a main boss to a center cover provided with an connecting boss corresponding to the main boss;
inserting a door glass to a lower portion at an inner circumference of the upper cover; and
connecting a lower cover provided with an connecting boss groove corresponding to the connecting boss of the center cover to a lower portion of the center cover.

19. The assembling method of claim 18, further comprising the step of fixing a fitting member into an inner portion of the connecting boss and the connecting boss groove.

20. The assembling method of claim 18, wherein the step of connecting the upper cover to the center cover includes fixing a hook formed in the upper cover to a hook groove formed in the center cover.

21. The assembling method of claim 19, wherein the step of connecting the center cover to the lower cover includes coupling a center undercut formed in the center cover to a lower undercut formed in the lower cover.

22. The assembling method of claim 18, wherein the step of connecting the upper cover to the center cover includes coupling a center boss formed in the upper cover to a center boss groove formed in the center cover.

23. The assembling method of claim 22, wherein the step of connecting the upper cover to the center cover further includes fixing a fitting member into the center boss through the center boss groove.

24. The assembling method of claim 23, wherein the step of connecting the center cover to the lower cover further includes fixing a bottom hook groove formed in the center cover to a bottom hook formed in the lower cover.
